(19) United States
(12) Patent Application Publication
(10) Pub. No.: US 2008/0055319 A1
(43) Pub. Date: Mar. 6, 2008

(54) Apparatus and Method of Conversing Data

(76) Inventor: Jong Hyun Hwang, Gyeonggi-do (KR)

Correspondence Address: KED & ASSOCIATES, LLP, P.O. Box 221200, Chantilly, VA, 20153-1200, US

(21) Appl. No.: 11/631,331

(22) PCT Filed: Apr. 27, 2006
(86) PCT No.: PCT/KR06/01592

§ 371 Date: Dec. 29, 2006

(30) Foreign Application Priority Data
Apr. 27, 2005 (KR) 10-2005-0034823

(51) Int. Cl. G06F 15/00

(52) U.S. Cl. 345/501

(57) ABSTRACT

A data converting apparatus and a method of converting data are provided. The data converting apparatus includes a header extracting unit extracting a file size information, and an offset information about starting of an actual data in a header of a file, and erasing the header of the file; a data rearranging unit extracting data representing an actual image in the file and rearranging the extracted data using at least one of the file size information and the offset information extracted by the header extracting unit; and a data processing unit converting the rearranged data into a display output format. The method of converting data having a header includes: erasing the header of the data; rearranging the data except for the header; and converting the rearranged data into a corresponding output format.

### FIELD

The present invention relates to a data conversion, and more particularly, to a data converting apparatus and a method of converting data to output the converted output format.

### BACKGROUND ART

To display graphic files (GCF, PCX, JPEG, BMP, etc.) having an image form as a kind of the data on an output unit, various codecs that decode corresponding files are required to express the graphic files on the output unit.

The codecs express and decompress the graphic files in digital format. Various kinds of graphic files including a bitmap file have codecs for each corresponding compression format. Additionally, the compressed files are displayed on a screen using the corresponding codecs.

Accordingly, when the files contain same graphic images, each file has a respectively different size according to a type of a codec. Even though same graphic images are displayed, each image quality can be different. Moreover, when there is no corresponding codec for a specific graphic file, the image of the graphic file can not be displayed.

For example, a codec for a compression format of the bitmap file is necessary so that a computer can analyze the bitmap file to display a corresponding image on a screen.

As described above, the bitmap file stores an image by dividing the image into a plurality of dots, containing various colors, and also is suitable for a colorful and flexible graphic file such as a photo file.

However, the bitmap file has a limitation in processing a delicate line or form. When enlarging or reducing an image, a quality of the image becomes coarse or damaged. Additionally, since a bitmap file has information in units of a pixel, the size of the bitmap file is large.

Accordingly, a codec that decodes the bitmap file to be appropriate for characteristics of the output unit is required to display the bitmap file on a screen.

The codecs express and compress the graphic files in digital format. Additionally various kinds of graphic files UPG, GIF, BMP, etc.) have corresponding codecs, respectively, for each compression format. Thus, the compressed file can be displayed on a screen using a corresponding codec.

Accordingly, even though files have a same graphic, the size of each file and an image displayed on the screen are different, respectively, according to a type of a codec. Moreover, in case there is no corresponding codec for a specific graphic file, the image of the graphic file can not be displayed.

In using bitmap files, a codec corresponding to a compression format of a bitmap file is required so that a computer can analyze the bitmap file to display an original graphic file on a screen.

### SUMMARY

Accordingly, the present invention is directed to a data converting apparatus and a method of converting data that substantially obviates one or more problems due to limitations and disadvantages of related art.

An object of the present invention is to provide a data converting apparatus converting a structure of a graphic file and displaying an image without a corresponding exclusive codec for the graphic file when displaying the graphic file in an image file on a screen, and a method of converting data.

Another object of the present invention is to provide a data converting apparatus converting a graphic file into a necessary format for output by rearranging an actual data portion except for a header when displaying the graphic file.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a data converting apparatus including: a header extracting unit extracting a file size information, and an offset information about starting of an actual data in a header of a file, and erasing the header of the file; a data rearranging unit extracting data representing an actual image in the file and rearranging the extracted data using at least one of the file size information and the offset information extracted by the header extracting unit; and a data processing unit converting the rearranged data into a display output format.

In another aspect of the present invention, a method of converting data having a header is provided in which the method includes erasing the header of the data; rearranging the data except for the header; and converting the rearranged data into a corresponding output format.

In a further another aspect of the present invention, a method of converting data having a header is provided in which the method includes reading the data except for the header; extracting a predetermined information in units of the read data; and converting the extracted information into a corresponding output format.

In a data converting apparatus and a method of converting data of a bitmap file, actual data of a bitmap file that stores an actual image upside down is rearranged to display an image on a screen without a codec. Additionally, data is converted and provided according to a graphic mode that a display supports.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a structure in a bitmap file;

FIG. 2 is a table of header information in a bitmap file;

FIG. 3 is a view of an original image file and a stored image file;

FIG. 4 is a view of header information with a loaded original bitmap file in (a), (b), and (c) according to an embodiment of the present invention;

FIG. 5 is view of a new data file rearranged in an original address form by extracting a data portion except for a header of a bitmap file in (a) and (b);

FIG. 6 is view of processes converting a rearranged data into a corresponding output format;

FIG. 7 is a block diagram of a structure in an apparatus converting a bitmap file;

FIG. 8 is a flowchart of a method of converting a bitmap file according to an embodiment of the present invention;

FIG. 9 is a flowchart of a method of rearranging the data of FIG. 8;

FIG. 10 is a flowchart of a method of converting and storing the data of FIG. 8; and

FIGS. 11 and 12 are firmware codes performing a data conversion.

### DETAILED DESCRIPTION

Reference will now be made in detail to preferred embodiments of the present invention, examples of which are illustrated in the accompanying drawings. Wherever possible, the same reference numbers will be used throughout the drawings to refer to the same or like parts.

A data converting apparatus and a method of converting data without a codec will be described. The conversion of a bitmap (BMP) file (i.e., a kind of a graphic file) will be described as an example.

The data includes files with an image, a graphic, and a text.

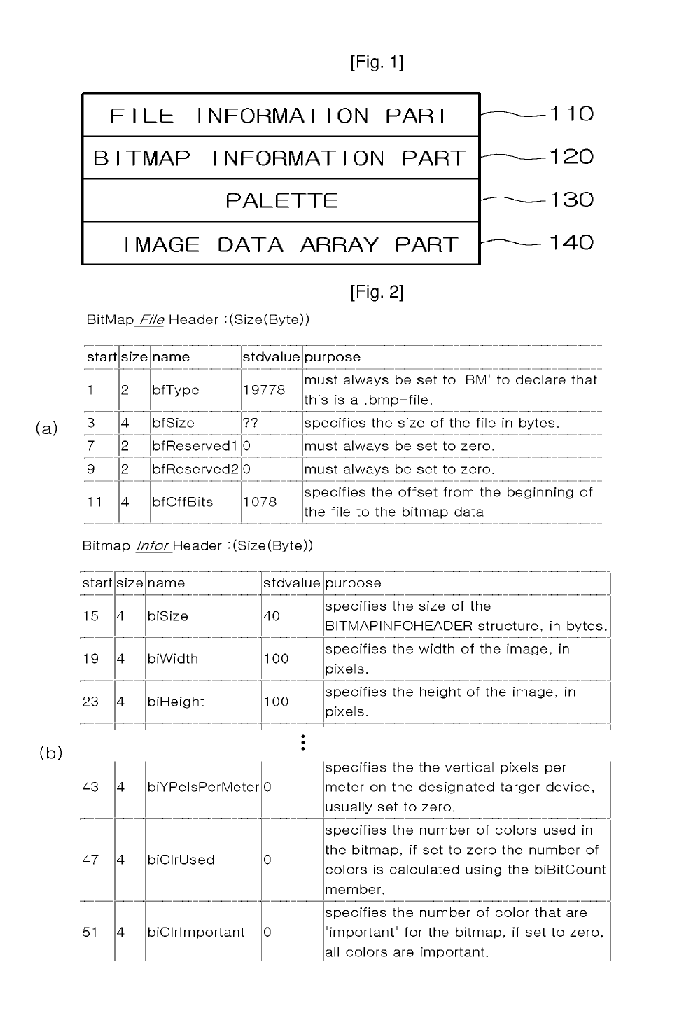

FIG. 1 is a block diagram of a structure in a bitmap file.

Referring to FIG. 1, a bitmap file mainly includes a file information part 110, a bitmap information part 120, a palette 130, and an image data array unit 140.

The file information part 110 stores information about a bitmap file. The information includes a display identifier BM letter representing the bitmap file, an integer of four bytes representing the size of the bitmap file, two fields for a reserved value, and an offset information regarding distance from an actual image bit.

Additionally, the bitmap information part 120 stores information on the bitmap file itself. The information includes the size of a structure, a width and height of an image, the numbers of bit planes, the number of bits for each pixel, a compression format, the size of an image, a vertical and horizontal resolution, the number of actually used colors, and an important color index.

Except for a true color, the palette 130 includes each color information according to the number of colors. For example, in a case of four grays, four color information (white 1, black 1, and gray 2) can be represented with two bits.

In a related art bitmap file (i.e., bmp file), the image data array part 140 stores pixel values of a row data in an image data without compression.

That is, in a case of four grays, four color information (white 1, black 1, and gray 2) can be represented with two bits. In a case of eight grays, eight color information can be represented with three bits.

FIG. 2(a) is a table of the file information part 110 in FIG. 1. FIG. 2(b) is a table of the bitmap information part 120 in FIG. 1.

As illustrated in FIG. 2, the file information part 110 (BitMap File Header) includes 14 bytes, and the bitmap information part 120 (BitMap Information Header) includes 40 bytes.

Accordingly, the header information can be erased on the basis of the header information, and then the actual data information can be extracted. For rearrangement, an address position is changed and stored.

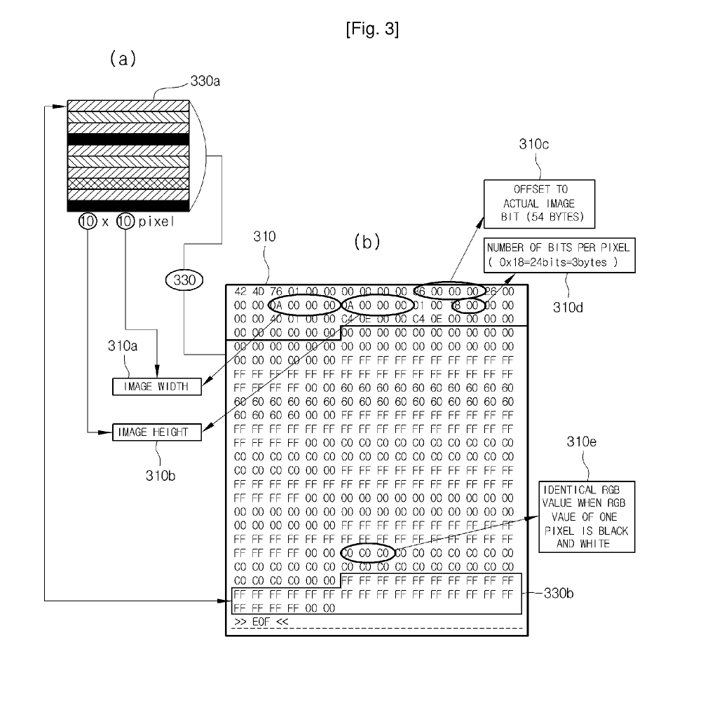

FIG. 3(a) is a view of an original image file 330, and FIG. 3(b) is view of an image stored upside down in a hexadecimal format as well as showing the header information of FIG. 3(a).

As illustrated in FIG. 3, a read portion on a top of an original image file 330 in FIG. 3(a) is stored on a bottom of the image file as shown in FIG. 3(b).

Generally, when the bitmap file is stored in memory, it is stored from a left bottom, and also a horizontal line is stored in a multiple of four bytes. For example, when an image expressed with eight bits for each pixel has a horizontal line of thirty pixels, the number of efficiently required bytes is thirty two bytes not thirty bytes.

As illustrated in FIG. 3(b), a header information 310 of the image is stored on a top of the image file as shown in FIG. 3(b).

The header information 310 includes information 310c on an offset to the actual image bit, information 310a on an image width of 10 bytes, information 310b on an image height of 10 bytes, information 310d on 24 bits (3 bytes) in each pixel, and information 310e on an RGB value of each pixel having an identical value.

In the bitmap file having a hexadecimal format, FF, 80, 00, CO represent RED, GREEN, BLACK, and GRAY, respectively.

Accordingly, when only an image information in the stored information with the header information is stored, the header information is separated, and then only the data portion is read and rearranged in an original form.

The data can include a file with an image, graphic, and text. An image, graphic, or bitmap file is used as data to describe the present invention for convenience, but it is apparent that the present invention can be identically applied to other data.

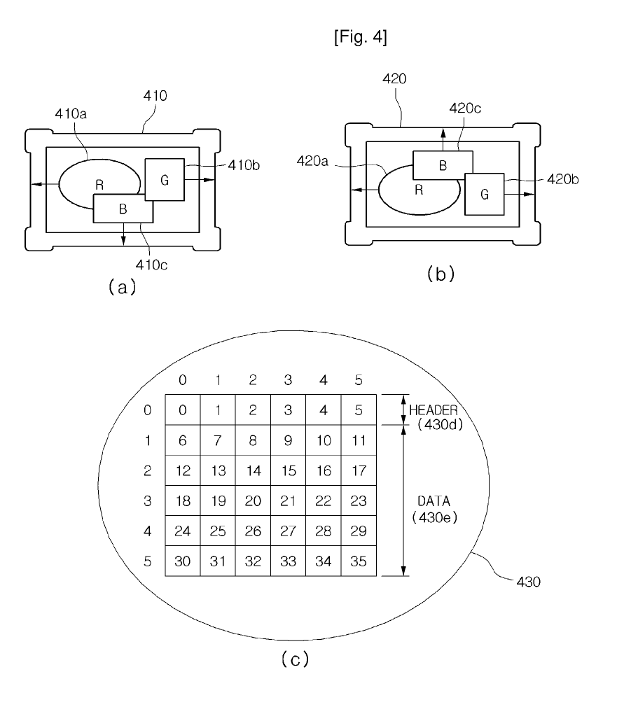

FIG. 4 is view of a bitmap file conversion.

When a bitmap file in RGB (Red, Green, and Blue) can be displayed on a full dot LCD of an output format without a codec, data of the bitmap file is rearranged and converted into a predetermined gray (e.g., four grays).

FIG. 4(a) shows an example image. The image in an original bitmap includes R(410a), G(410b), and B(410c). Additionally, FIG. 4(b) is a view of a stored image. The stored image is in an opposite position with respect to the actual image 330a like a data arrangement 330b shown in FIG. 3. However, this arrangement is limited to a bitmap image, and can be different for other image formats. The bitmap image 420 includes R(420a), G(420b), B(420c), and an address structure includes an image data 430e and header 430d as shown in the image 430 of FIG. 4(c).

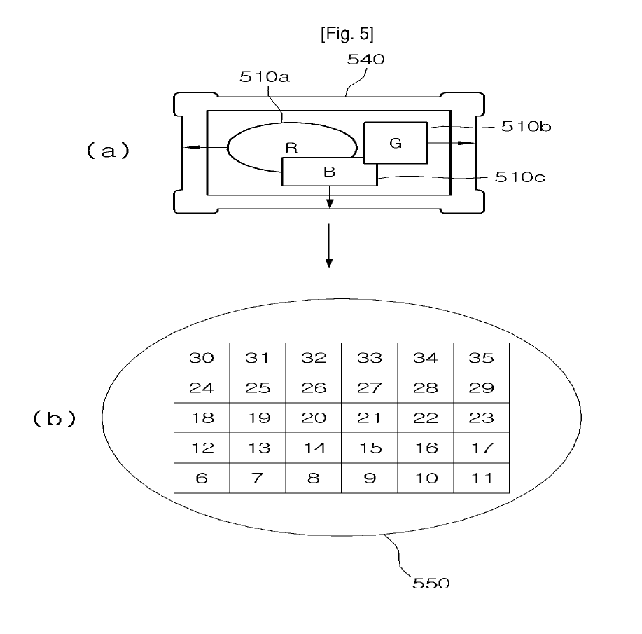

In FIG. 5(a), the data portion 430e except for the header 430d in the bitmap file of FIG. 4(b) is extracted, and then the new data file is rearranged such as shown as a table 550 in FIG. 5(b). Since addresses of the bitmap format are opposite to that of the actual image, it is convenient for encoding and decoding in the data structure. This can be applied to other files (e.g., jpg, png, gif, tif, tiff, etc.).

Accordingly, the rearranged data file is outputted by converting pixel information having an address into a format corresponding to a predetermined output form.

First, a general description will be provided.

A required data is processed to display the rearranged data on the full dot LCD, and when the LCD supporting four level grays is used, the processes are as follows.

One byte value is selected from an RGB data of three bytes, which are used to express one pixel. Since each byte represents an RGB value to express a color, the RGB value is identical in a case of black and white. Thus, one byte of the three bytes of the RGB data can represent the black and white.

For example, four expression methods are required to express four grays with one byte, and in this case, one byte (which is 8 bits and can express 256 colors) is unnecessary to express the four grays. Only two bits can represent the four grays. However, when a high resolution (e.g., eight grays or sixteen grays) is displayed, more bits are required. The expression of four grays is described using two bits as shown below.

(1,1): gray-scale 3 Black

(1,0): gray-scale 2 Gray 1

(0,1): gray-scale 1 Gray 1

(0,0): gray-scale 0 White

Four expressions, that is, (0,0), (0,1), (1,0), and (1,1) represent White, Gray1, Gray2, and Black, respectively. The Gray-scale 0 to the Gray-scale 3 are predetermined values. One byte extracted from the three bytes of the RGB data is hexadecimal values. Since a certain reference is required to convert a hexadecimal value into a binary value, the hexadecimal value is a predetermined value.

When a gray-scale 0 value is designated as below 0xFF and above 0xBF, one byte is converted into two bits, that is, (0,0) when the one byte includes small numbers such as 0xFE, 0xE0, etc. Consequently, eight bits (one byte) becomes two bits.

Transmission to an LCD data RAM is performed by one byte, and data of the one byte is eight bits. Thus, the one byte includes information regarding four pixels. As described above, the data is sequentially stored from left to right. When one byte data is transmitted from an arbitrary pixel X point, one byte is formed of data of pixels (i.e., X, X+width, X+2width, and X+3width).

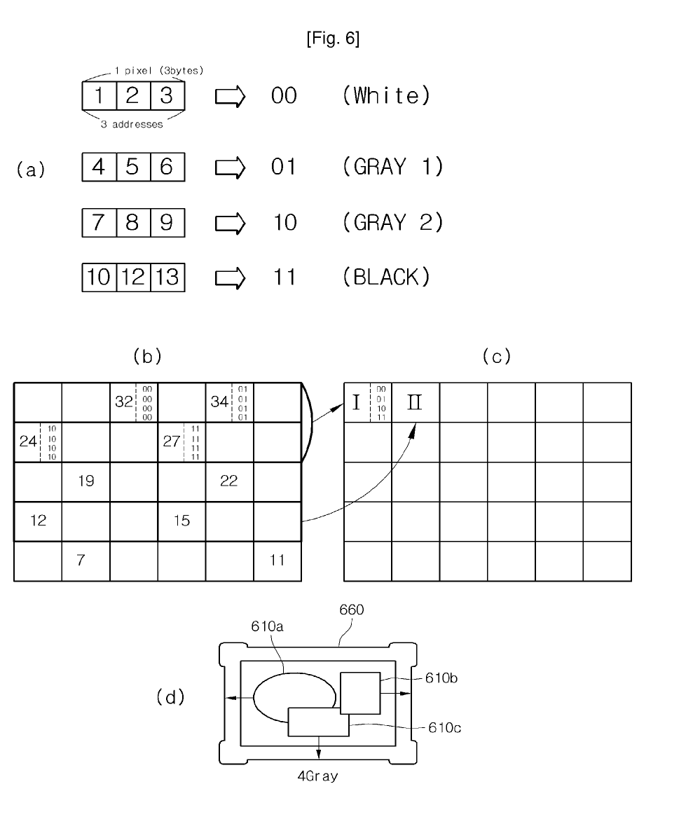

After one byte is selected from the one pixel with three bytes in FIG. 6(a), a hexadecimal value is converted into a binary value (2 bits) to display four grays as illustrated in FIG. 6(b).

Referring to FIG. 6(c), the converted binary values in four selected bytes (address 32, 34, 24, and 27) are combined to represent one byte I.

FIG. 6(d) is a view of a reconverted image for four grays.

As illustrated in FIG. 6, the reconverted image 660 includes a converted R 610a, G 610b, and B 610c.

Additionally, simple structures 430 and 550 in FIGS. 4 and 5 are views of the rearranged data. Referring to the address structure 430 of the bitmap file 420 in FIGS. 4(b) and 4(c), the size information in the header includes a data size information in width 6 and height 6 and information on offset 6. Accordingly, an actual data begins with an address number 6, and is stored upside down as shown in FIG. 4.

Accordingly, after an address number 30 to address number 35 (width six) in a bottom line are stored, an address number 24 to an address 29 (width 6) are stored in a top line to rearrange the actual data using an original image. This process repeats for storing.

Using the processes described above, as illustrated in FIG. 5(b), the data is rearranged and stored in an address number structure 550 corresponding to the new data file 540.

When a display device can support an RGB color in the address structure 550 of the new data file 540, an image can be displayed on the screen. When an output format of the display device is a full dot LCD, the data is converted into four grays one more, and then the reconverted file 550 can be displayed as shown in FIG. 6(d).

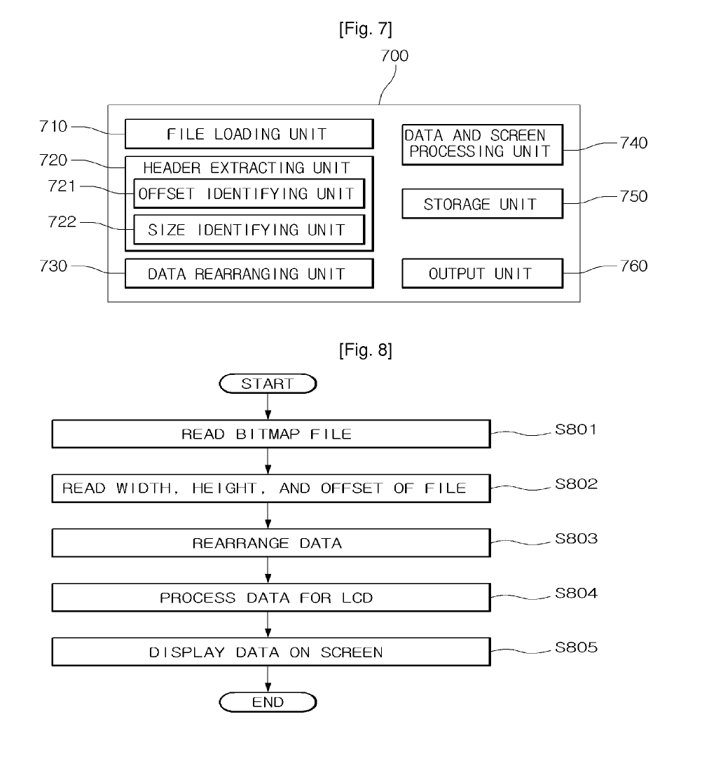

FIG. 7 is a block diagram of a structure in a bitmap file converting apparatus.

Referring to FIG. 7, the bitmap file converting apparatus displays a bitmap file on the full dot LCD. The bitmap file converting apparatus includes a file loading unit 710 loading a bitmap file, a header extracting unit 720 extracting the size of the file and an offset information regarding the beginning of an actual data after extracting only the header of the bitmap file loaded by the file loading unit 710, a data rearranging unit 730 rearranging the actual data of the bitmap file to be in an original image order using the file size and the offset information extracted from the header extracting unit 720, a data and screen processing unit 740 converting the data rearranged by the data rearranging unit 730 into four gray data to be displayed on the fill dot LCD, a storage unit 750 storing the data processed by the data and screen processing unit 740, and an output unit 760 outputting the data stored on the storage unit 750 onto the screen.

At this point, the header extracting unit 720 includes a size identifying unit identifying the size information of the file and an offset identifying unit 721 identifying information regarding the beginning of an actual data.

Additionally, the header extracting unit 720 extracts and removes the header from the loaded data. The size identifying unit 722 identifies the size information of a corresponding bitmap file in the extracted header. The offset identifying unit 721 identifies the offset information regarding a distance between the header and the actual data.

The data rearranging unit 730 rearranges the data of the bitmap file using the size of the actual file identified by the size identifying unit 722 and the offset information identified by the offset identifying unit 721.

When the data rearranging unit 730 rearranges the data of the bitmap file, an actual data portion 430e of the bitmap file 430 stored upside down in FIG. 4 is rearranged into the original image 540 of FIG. 5, which is identical to the image 410 of FIG. 4. A detailed description will be made separately.

When an output unit is a color monitor supporting an RGB, the rearranged data can be instantly displayed. Additionally, when the output unit is a full dot LCD supporting four grays, the data with the RGB color needs to be converted into four grays.

Accordingly, the data and screen processing unit 740 for the LCD converts the data having the RGB value, which is rearranged by the data rearranging unit 730, into four gray data. The processing method will be described separately like the data rearrangement method.

The four gray data processed by the data and screen processing unit 740 is stored in the storage unit 750, and the output unit 760 displays the data stored in the storage unit 750 on the screen.

A method of converting a bitmap file will now be described in more detail.

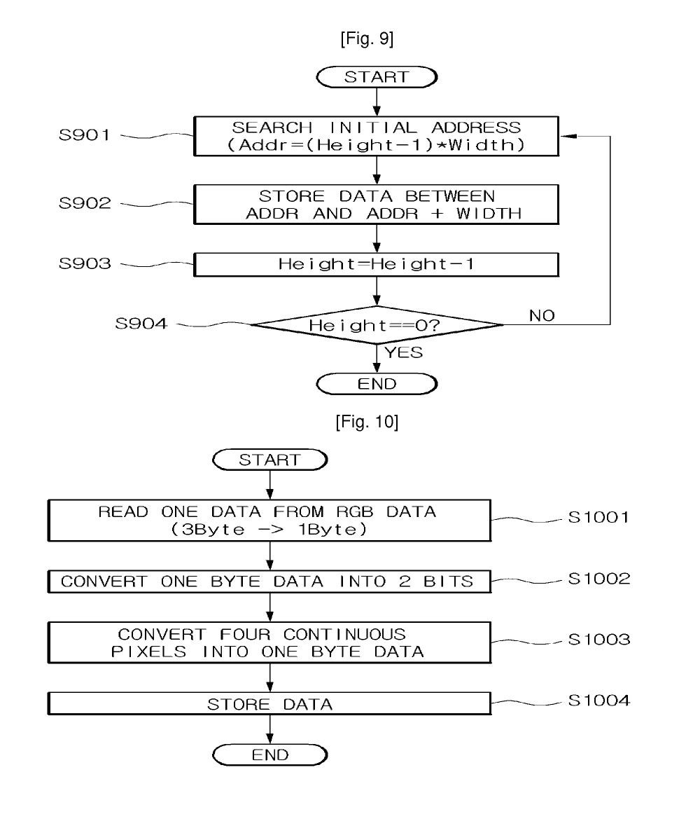

FIG. 8 is a flowchart of a method of converting a bitmap file according to an embodiment of the present invention. FIG. 9 is a flowchart of a method of rearranging the data of FIG. 8. FIG. 10 is a flowchart of a method of converting and storing the data of FIG. 8.

Referring to FIGS. 7 to 10, the file loading unit 710 loads the bitmap file to display the bitmap file on the full dot LCD in operation S801. Additionally, the header extracting unit 720 extracts a header of the data that is loaded using the offset information.

In operation S802, the size identifying unit 722 of the header extracting unit 720 identifies the size information regarding the height and the size of the bitmap file from the extracted header. The offset identifying unit 721 identifies the offset information regarding the beginning of the actual data.

Referring to FIGS. 4 and 7, the file loading unit 710 loads a structure 430 of an original bitmap file. The header extracting unit 720 extracts the header. The size identifying unit 722 identifies a width 6 and height 6 information of the actual data size. The offset identifying unit 721 identifies an offset 6 which is a distance between the actual data and the header.

After identifying the size information and the offset information in the operation S802, the data rearranging unit 730 rearranges the upside down bitmap file. The rearrangement order is described in more detail with reference to FIG. 9.

The following regards an assumption that width is 6, height is 6, and offset is 6.

Referring to FIG. 9, when the data rearranging unit 730 rearranges the data of the bitmap file, a data starting address is searched first in operation S901. Based on the above assumption, the data starting address is an initial address ((6−1)*6=30) by the offset 6.

After the initial address is found, data (Addr+Width) of the initial address plus the width is stored in operation S702. That is, data of addresses 30 to 35 is stored.

After storing the data, an initial address is set to store the right above data by reducing a height value by 1 in operation S903. Whether the result of the reducing of the height value is zero or not is determined in operation S904. When the result is not zero, the data is stored by repeating the operations from the S901 operation.

More specifically, referring to the bitmap file address structure 430 of FIG. 4(c), after the data of the addresses 30 to 35 in a lowest bottom is stored in the operation S902, the height 6 is reduced to the height 5, which is in right above of the lowest bottom, to store the data of addresses 24 to 29 in the operation S903. Then, whether the result of the reducing of the height value is zero or not is determined in operation S904. An initial address 24 is calculated through the operation S901, and then the data of addresses 24 to 29 is stored repeatedly.

When the height is 0 in the operation S904, it is determined that all data arrangement is finished, and the rearrangement operations terminate.

After data rearrangement in the operation S803 of FIG. 8 is performed by a flowchart of FIG. 9, the data and screen processing unit 740 performs reprocessing operations to display the rearranged data on the fill dot LCD with four grays in operation S804.

FIG. 10 is a view of the rearranged data reprocessing operation S804.

Referring to FIG. 10, one pixel includes an RGB value of three bytes in the bitmap file of the RGB color, and one of the RGB values is read to display four grays on the full dot LCD in operation S1001.

When an RGB value in one pixel represents a black and white in four grays, the RGB value is the same, and thus any one of the RGB values can be selected to identify a color. Additionally, three bytes for one pixel are reduced to one byte.

One byte in the operation S1001 needs to be transmitted to RAM storing the LCD data, and then is displayed on the full dot LCD. For this, the one byte value is converted into two bits in operation S1002.

The reason for converting the one byte into the two bits is to express four gray colors of a gray-scale 3 (black), a gray-scale 2 (brighter than the gray-scale 3), a gray-scale 1 (brighter than the gray-scale 2), and a gray-scale 0 (white) in the fill dot LCD.

That is, the four gray colors can be expressed as follows.

Gray-scale 3=(1,1)

Gray-scale 2=(1,0)

Gray-scale 1=(0,1)

Gray-scale 0=(0,0)

Accordingly, the one byte in the operation S1001 is converted into the two bits to express four grays.

The data is transmitted to the RAM in one byte units to be displayed on the full dot LCD.

At this point, since one byte includes eight bits, four pixels (each pixel with two bits) can be stored, and then transmitted. The data and screen processing unit 740 converts the continuous four pixels into one byte data in operation S1003, and then stores the one byte in the storage unit 750 in operation S1004.

In the operation S1001 to the operation 1004, the bitmap file in the RGB colors is converted into the data in four grays, and the converted data is stored in the storage unit 750. Then, the output unit 760 transmits the data to the RAM of the full dot LCD by one byte units, and thus, the data is displayed on the display in operation S805.

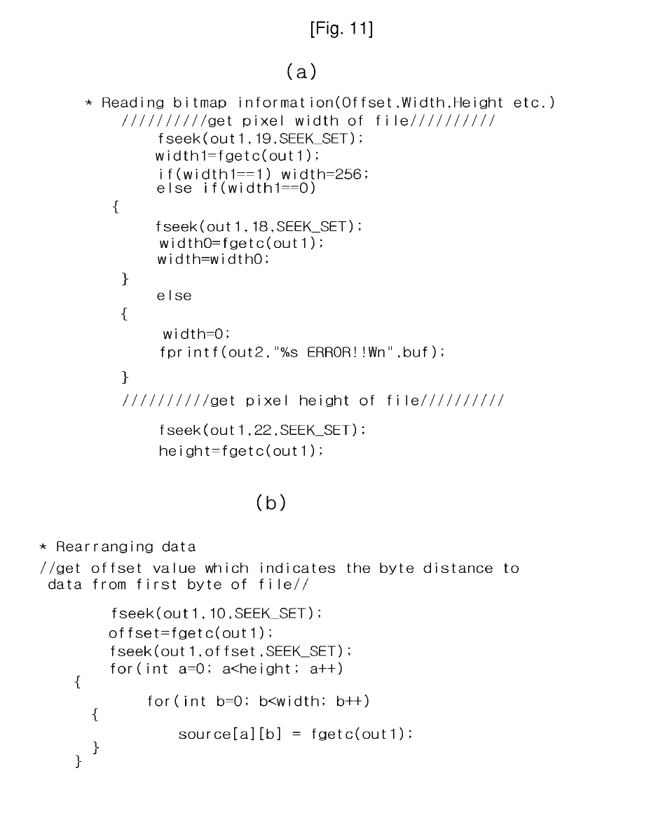

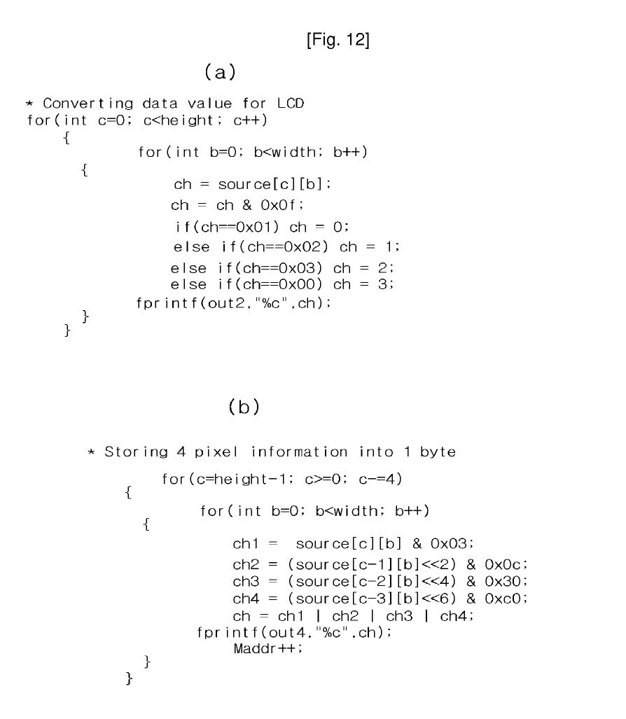

FIGS. 11 and 12 are firmware codes for performing a data conversion.

As illustrated in FIGS. 11 and 12, the firmware codes include loading a bitmap information having an original image and header information, rearranging the loaded information except for the header information, and converting the rearranged information into an output format.

As described above, the present invention relates an apparatus and a method of converting a bitmap file by extracting actual data in the bitmap file and then rearranging the data. Thus, the bitmap file can be displayed on the screen without a codec. In the case of a four-gray LCD, the bitmap file with the RGB color is converted into four gray data and then the data is stored, which can support the four grays. Moreover, the size of the data is reduced and the data can be displayed on the LCD without a codec.

It is apparent that the various embodiments are possible when selectively including components within the scope of the present invention.

For example, in a case of four grays, the gray information can be stored in one byte at each pixel rather than three bytes at each pixel. Additionally, the one byte with the gray information can be converted into two bits. Thus, memory capacity can be reduced by one twelfth.

On the other hand, in a case of eight grays, the gray information can be stored in one byte. Additionally, the one byte with gray information can be converted into three bits (two of three bits in one byte). Accordingly, the memory capacity can be reduced by one sixth.

The present invention is applicable to fields for converting data and outputting the converted data.

It will be apparent to those skilled in the art that various modifications and variations can be made in the present invention. Thus, it is intended that the present invention covers the modifications and variations of this invention provided they come within the scope of the appended claims and their equivalents.

1. A method of converting data having a header, the method comprising:
receiving the data having the header; rearranging the data except for the header; and
converting the rearranged data into a desired output format.

2. The method according to claim 1, wherein rearranging the data includes rearranging the data except for the header based on data starting information provided in the header.

3. The method according to claim 2, wherein rearranging the data further includes rearranging the data except for the header in an upside down and left to right manner based on the data starting information in the header.

4. A method of converting data having a header, the method comprising:
reading the data;
extracting predetermined information from the read data; and
converting the extracted information into a specific output format.

5. The method according to claim 4, wherein the predetermined information is stored in units of three bytes per one pixel.

6. The method according to claim 5, wherein extracting the predetermined information includes extracting one byte from the three bytes for each pixel.

7. The method according to claim 4, wherein gray information in the extracted one byte is read according to gray information to be outputted and is represented using a predetermined byte unit.

8. The method according to claim 7, wherein gray bit information is represented by more than one byte in the gray information for each pixel converted into more than one byte.

9. The method according to claim 7, wherein different gray information is extracted from common gray information in each byte, and is stored in more than one byte.

10. The method according to claim 7, wherein each of four grays is represented using two bits, and the four grays are represented as one byte.

11. A data converting apparatus comprising:
a header extracting unit to extract, from a header of a file, a file size information and an offset information regarding a starting location of an actual data;
a data rearranging unit to extract data representing an actual image from the file and to rearrange the extracted data using at least one of the file size information and the offset information extracted by the header extracting unit; and
a data processing unit to convert the rearranged data into a display output format.

12. The data converting apparatus according to claim 11, further comprising:
a data and screen processing unit to reconvert the rearranged data into a color mode that is supported by a display device; and
a storage unit to store the reconverted data of the data and screen processing unit.

13. A method of converting data, comprising:
extracting file size information and offset information about a location of actual data based on a header of a file;
rearranging the actual data of the file using the extracted file size information; and
storing the rearranged data.

14. The method according to claim 13, further comprising:
reconverting and outputting the rearranged data to be appropriate for a color format of a display device.

15. The method according to claim 13, wherein the file size information represents height and width information of the data in a bitmap file.

16. The method according to claim 13, wherein the rearranging of the actual data comprises:
calculating a data starting address using height and width information of the file;
storing the data based on the calculated data starting address, the height information and the width information provided in the header.

17. The method according to claim 16, wherein the storing of the data is based on the calculated starting address, the reduced height information and the width information until the reduced height becomes zero.

18. The method according to claim 13, wherein the file comprises a graphic file including at least one of bmp, jpg, png, gif, tif, or tiff.

19. The method according to claim 13, further comprising erasing the header based on the extracted offset information.

20. The method according to claim 16, wherein storing the data includes sequentially reducing a value of the height information.

21. The method according to claim 1, further comprising displaying an image on a screen in the desired output format based on the converted rearranged data.

22. The method according to claim 17 further comprising erasing the header based on offset information provided in the header, the erasing being performed after receiving the data having the header.

23. The method according to claim 1, further comprising storing the converted rearranged data.

24. The method according to claim 1, wherein rearranging the data is performed based on height and width information provided within the header.

25. The method according to claim 1, wherein rearranging the data further includes calculating a data starting address based on the height and width information.

26. The method according to claim 11, wherein the header extracting unit erases the header of the file.
